(19) United States
(12) Patent Application Publication
(10) Pub. No.: US 2024/0362040 A1
(43) Pub. Date: Oct. 31, 2024

(54) COMPUTER-READABLE STORAGE MEDIUM, INFORMATION PROCESSING DEVICE, AND METHOD FOR CUSTOMIZING PRINT SETTING SCREEN

(71) Applicant: BROTHER KOGYO KABUSHIKI KAISHA, Nagoya (JP)

(72) Inventor: Kenju NARITA, Nagoya (JP)

(21) Appl. No.: 18/764,496

(22) Filed: Jul. 5, 2024

Related U.S. Application Data
(63) Continuation of application No. PCT/JP2023/004921, filed on Feb. 14, 2023.

(30) Foreign Application Priority Data
Feb. 24, 2022 (JP) 2022-026765

(51) Int. Cl. G06F 9/451; G06F 3/12

(52) U.S. Cl. CPC G06F 9/451; G06F 3/1205

(57) ABSTRACT

A non-transitory computer-readable storage medium stores computer-readable instructions that are compatible with a printer connected with an information processing device and support a general-purpose print program incorporated in advance in an operating system of the information processing device. The instructions are configured to, when executed by a computer of the information processing device, cause the information processing device to read, in response to receiving a processing request from the general-purpose print program when the printer is selected, setting data indicating settings for customizing a print setting screen, generate, based on the settings indicated by the read setting data, display data indicating contents to be displayed on the print setting screen, and send the generated display data to the general-purpose print program, thereby causing the print setting screen to be displayed on a display of the information processing device in accordance with the display data via the general-purpose print program.

### REFERENCE TO RELATED APPLICATIONS

This application is a continuation of PCT International Application No. PCT/JP2023/004921 filed on Feb. 14, 2023, and claims priority from Japanese Patent Application No. 2022-026765 filed on Feb. 24, 2022, which are incorporated herein by reference in their entirety.

### BACKGROUND ART

Heretofore, a technology for customizing a print setting screen displayed by a printer driver has been known. For instance, a configuration has been disclosed in which customization data is installed as well when a print setting application compatible with the printer driver is installed, and the print setting application displays the print setting screen in accordance with the customization data.

### SUMMARY

In recent years, a technology has been put to practical use in which a printer is controlled by a general-purpose print program that is incorporated as standard into an operating system (hereinafter referred to as the “OS”) of an information processing device, without using a printer driver. In this technology, the OS associates the printer with the OS-standard general-purpose print program in response to detecting the printer, and thereafter, the information processing device is enabled to cause the printer to perform printing with the OS-standard general-purpose print program without using a printer driver in response to receiving a print instruction to the printer.

However, there is no known configuration for customizing a print setting screen displayed by the OS-standard general-purpose print program in accordance with specifications of a printer, in an information processing device using the OS-standard general-purpose print program. Therefore, there is room for improvement in the technology for displaying the print setting screen in an environment using the OS-standard general-purpose print program.

According to aspects of the present disclosure, a non-transitory computer-readable storage medium is provided, which stores computer-readable instructions that are executable by a computer of an information processing device and compatible with a printer connected with the information processing device. The instructions support a general-purpose print program incorporated in advance in an operating system of the information processing device. The instructions are configured to, when executed by the computer, cause the information processing device to read, in response to receiving a processing request from the general-purpose print program when the printer is selected, setting data indicating settings for customizing a print setting screen. The general-purpose print program is configured to, when executed by the computer, cause the information processing device to display the print setting screen on a display of the information processing device. The instructions are further configured to, when executed by the computer, cause the information processing device to generate, based on the settings indicated by the read setting data, display data indicating contents to be displayed on the print setting screen. The instructions are further configured to, when executed by the computer, cause the information processing device to send the generated display data to the general-purpose print program, thereby causing the print setting screen to be displayed on the display in accordance with the display data via the general-purpose print program.

According to aspects of the present disclosure, further provided is an information processing device that includes a display and a controller. The controller includes a computer and a non-transitory computer-readable storage medium. The non-transitory computer-readable storage medium stores a general-purpose print program incorporated in advance in an operating system of the information processing device, and computer-readable instructions that are compatible with a printer connected with the information processing device and support the general-purpose print program. The instructions are configured to, when executed by the computer, cause the controller to read, in response to receiving a processing request from the general-purpose print program when the printer is selected, setting data indicating settings for customizing a print setting screen. The general-purpose print program is configured to, when executed by the computer, cause the controller to display the print setting screen on the display. The instructions are further configured to, when executed by the computer, cause the controller to generate, based on the settings indicated by the read setting data, display data indicating contents to be displayed on the print setting screen. The instructions are further configured to, when executed by the computer, cause the controller to send the generated display data to the general-purpose print program, thereby causing the print setting screen to be displayed on the display in accordance with the display data via the general-purpose print program.

According to aspects of the present disclosure, further provided is a method implementable by a computer executing computer-readable instructions on an information processing device. The instructions are compatible with a printer connected with the information processing device and support a general-purpose print program incorporated in advance in an operating system of the information processing device. The method includes reading, in response to receiving a processing request from the general-purpose print program when the printer is selected, setting data indicating settings for customizing a print setting screen. The general-purpose print program is configured to, when executed by the computer, cause the information processing device to display the print setting screen on a display of the information processing device. The method further includes generating, based on the settings indicated by the read setting data, display data indicating contents to be displayed on the print setting screen. The method further includes sending the generated display data to the general-purpose print program, thereby causing the print setting screen to be displayed on the display in accordance with the display data via the general-purpose print program.

### BRIEF DESCRIPTION OF DRAWINGS

FIG. 1 is a block diagram schematically showing an electrical configuration of a PC.

FIG. 2 is a sequence chart showing an example of a procedure when “Print” is selected.

FIG. 3 shows an example of a print setting screen.

FIGS. 4A and 4B show examples of contents displayed on the print setting screen.

FIGS. 5A and 5B show examples of contents displayed on the print setting screen.

FIGS. 6A and 6B show examples of contents displayed on the print setting screen.

FIG. 7 shows an example of contents displayed on the print setting screen.

FIG. 8 is a sequence chart showing an example of a procedure when a print instruction has been received.

FIG. 9 is a flowchart showing an example of a control procedure of a registration process.

FIG. 10 shows an example of a customization screen.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.”

A detailed explanation will be provided below of a personal computer (hereinafter referred to as the “PC”) using a support program in an illustrative embodiment according to aspects of the present disclosure, with reference to the accompanying drawings. In the present disclosure, a support program executable by the PC is described.

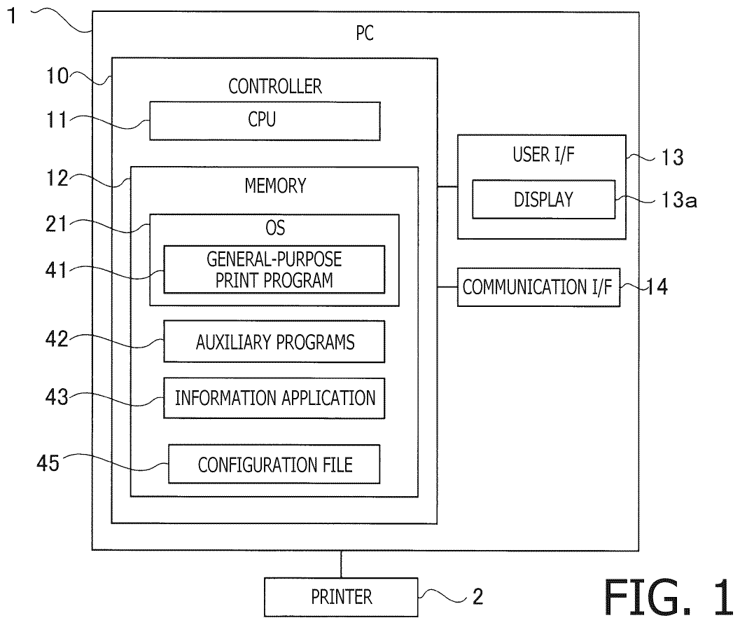

As shown in FIG. 1, a PC 1 of the illustrative embodiment has a controller 10 that includes a CPU 11 and a memory 12. The PC 1 may be an example of an “information processing device” according to aspects of the present disclosure. The CPU 11 may be an example of a “computer” according to aspects of the present disclosure. The PC 1 further includes a user interface (hereinafter referred to as the “user I/F”) 13 and a communication interface (hereinafter referred to as the “communication I/F”) 14, which are electrically connected with the controller 10. The “controller 10” in FIG. 1 is a collective term for hardware and software used to control the PC 1, and may not necessarily represent a single hardware element actually existing in the PC 1.

The CPU 11 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes hardware configured to display screens to provide information to the user, and hardware configured to receive user operations. The user I/F 13 may have a combination of a display 13a configured to display information, and a mouse and/or a keyboard that are configured to accept user input operations, i.e., having an input acceptance function. The user I/F 13 may include a touch panel having the display 13a and the input acceptance function. The user I/F 13 includes an example of a “display” according to aspects of the present disclosure.

The communication I/F 14 includes hardware configured to communicate with external devices such as a printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet via the communication I/F 14. The PC 1 may have a plurality of communication I/Fs 14 conforming to a plurality of communication standards.

As shown in FIG. 1, the memory 12 of the PC 1 stores an operating system (hereinafter referred to as the “OS”) 21 including a general-purpose print program 41, and further stores auxiliary programs 42 and various application programs (hereinafter, which may be referred to as the “applications”). Examples of the OS 21 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC).

The PC 1 in the illustrative embodiment incorporates various applications such as an information application 43. The information application 43 is, for instance, a map application, a calendar application, or a browser. The information application 43 is configured to, when executed by the CPU 11, cause the PC 1 to display various types of information on the display 13a in response to user requests. The information application 43 may be an example of an “application program” according to aspects of the present disclosure. The information application 43 itself may not necessarily have a function to print the displayed information.

The general-purpose print program 41 is an OS-standard program provided with the OS 21 and has a function to cause the printer 2 to print information that is displayed on the display 13a by the information application 43. The general-purpose print program 41 in the illustrative embodiment is a program having a function for generating intermediate image data based on image data to be printed. The general-purpose print program 41 supports functions that are usable in common by a plurality of printer models provided by vendor(s) of various printers. Unlike printer drivers that are specific to individual printers, the general-purpose print program 41 does not support all of the functions that are unique to the individual printers. Functions supportable by the general-purpose print program 41 are limited to generic functions.

The auxiliary programs 42 include one program or a group of programs configured to, when executed by the CPU 11, cause the PC 1 to perform processing based on instructions from the OS 21, accompanying processing by the general-purpose print program 41. The auxiliary programs 42 include one or more programs that support control of target hardware elements. The auxiliary programs 42 in the illustrative embodiment are compatible with a model of the printer 2 connected with the PC 1. The auxiliary programs 42 are launched from the general-purpose print program 41, for instance, when the PC 1 has received an instruction to cause the printer 2 to perform printing using the general-purpose print program 41. The auxiliary programs 42 are called, for instance, PSA (“PSA” is an abbreviation for “Print Support Application”) or HSA (“HAS” is an abbreviation for “Hardware Support Application”).

For instance, the auxiliary programs 42 may include a combination of a plurality of programs each of which is configured to, when executed by the CPU 11, cause the PC 1 to accept execution instructions. In another instance, the auxiliary programs 42 may include one program configured to, when executed by the CPU 11, cause the PC 1 to accept instructions and perform respective different processes according to the accepted instructions. The auxiliary programs 42 may include a program prepared for each type of printer by the printer vendor(s). For instance, the auxiliary programs 42 may include an auxiliary program prepared for inkjet printers and an auxiliary program prepared for laser printers. The auxiliary programs 42 may include not only the auxiliary program prepared for each type of printer but also an auxiliary program prepared for each model of printer or an auxiliary program prepared for each series of models of printers.

For instance, when a new printer is connected with the PC 1, the OS 21 may cause the PC 1 to download an appropriate auxiliary program from a server or another source depending on a type of the connected printer and to incorporate the downloaded auxiliary program into the PC 1. Then, the OS 21 may cause the PC 1 to store identification information of the incorporated auxiliary program in the memory 12 in association with printer information of the newly connected printer.

As shown in FIG. 1, the PC 1 in the illustrative embodiment is connected with the printer 2. The printer 2 has at least a printing function and a communication function. The printer 2 is configured to receive print data and print settings from an external device such as the PC 1 and perform printing according to the print settings. Examples of setting items (hereinafter, which may be referred to as “print setting items” or simply as “items”) for the print settings may include, but are not limited to, “Number of Copies,” “Print Orientation,” “Print Quality,” “Sheet Size,” “Feed Tray,” “Sheet Type,” “Duplex Printing,” “Color Printing,” and “Borderless Printing.”

In addition to the aforementioned items, examples of the print setting items may further include processing options for processing a target image to be printed. Examples of the processing options may include, but are not limited to, “Layout Printing,” “Booklet Printing,” and “Poster Printing.” Layout Printing is a printing method for printing N (N is a natural number equal to or greater than two) pages of images reduced in size and arranged in order on a single sheet. Booklet Printing is a printing method for printing N (N is a natural number equal to or greater than two) pages of images that have been reduced and rearranged such that two pages are placed on each side of a single sheet. Poster Printing is a printing method for printing a single-page image enlarged to a poster size and divided into M (M is a natural number equal to or greater than two) sheets. Examples of the print setting items may further include post-processing that the printer 2 performs for a printed material. Examples of the post-processing may include, but are not limited to, “Staple” to fasten the printed material by staples.

The printer 2 is configured to accept various print settings based on the functions of the printer 2. The auxiliary programs 42 are configured to accept print settings via a print setting screen (hereinafter, which may be referred to as the “detailed setting screen”) dedicated to the printer 2. The detailed settings screen is configured to accept the same settings as settings configurable on the printer 2. The detailed setting screen may accept settings for items that are not configurable on the printer 2. For instance, if the auxiliary programs 42 perform specific processes for the processing options, but the printer 2 does not perform the specific processes, the detailed setting screen may accept settings for the processing options.

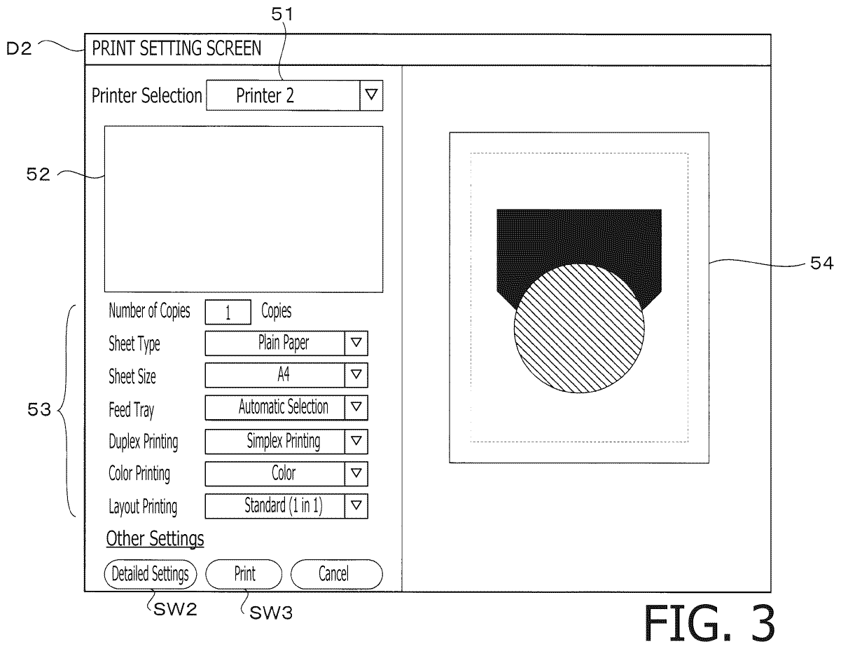

The general-purpose print program 41 is configured to accept print settings via a print setting screen D2 (see FIG. 3). The general-purpose print program 41 is further configured to handle data for causing the display 13a of the PC 1 to display the print setting screen D2. For instance, the general-purpose print program 41 is enabled to display information received from the auxiliary programs 42 on the print setting screen D2. Information that the general-purpose print program 41 is enabled to display may include, but are not limited to, items and parameters for the print settings, and notification images.

As shown in FIG. 1, a configuration file 45 is stored in the memory 12 of the PC 1. The auxiliary programs 42 have a registered location where the configuration file 45 is stored, and are enabled to read out the configuration file 45. The configuration file 45 stores setting data indicating settings for customizing what is to be displayed on the print setting screen D2. The setting data may include a list of targets to be displayed or a list of targets not to be displayed. The configuration file 45 may be a text file or a file in a defined format such as json, csv, or xml. The configuration file 45 may be prepared by the printer vendor or a system administrator to customize the operation of the printer 2, or by an individual user to improve convenience in using the printer 2. The registration of the configuration file 45 to be read is performed by an after-mentioned registration process.

The auxiliary programs 42 are enabled to customize what is to be displayed on the print setting screen D2 based on the setting data stored in the configuration file 45. Examples of settings for customization for the print setting screen D2 may include, but are not limited to, adding or deleting print setting items, adding or deleting parameters that are settable for each print setting item, changing the display order of the print setting items or the parameters that are settable for each print setting item, changing descriptions on the print setting screen D2, and changing images to be displayed on the print setting screen D2.

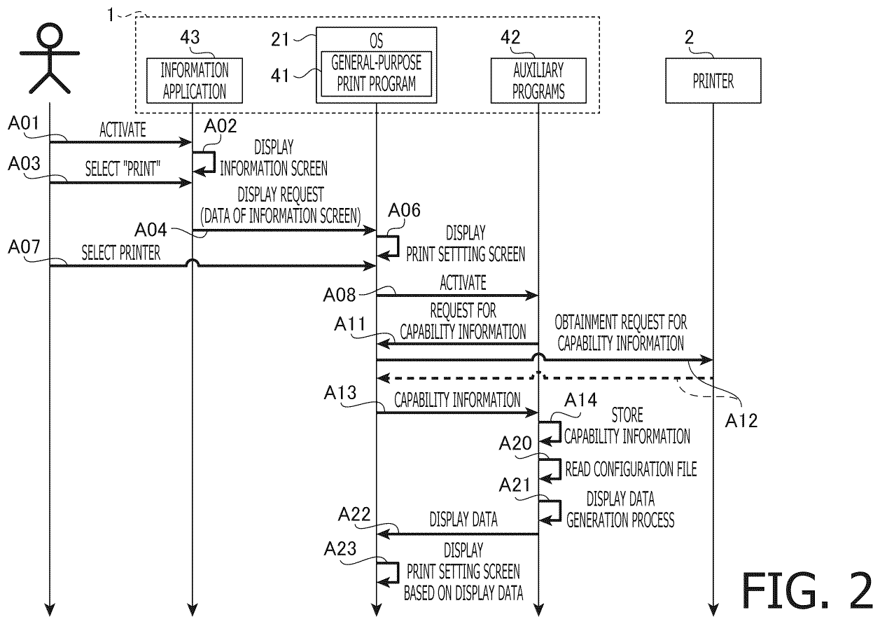

Next, an explanation will be provided of a procedure of printing that includes operations of the auxiliary programs 42 in the illustrative embodiment, i.e., a procedure of operations by the individual programs when printing is selected via the information application 43, with reference to a sequence chart in FIG. 2. In FIG. 2 and after-mentioned other sequence charts, operations when the auxiliary programs 42 compatible with the printer 2 are incorporated in the PC 1 are shown.

Each processing step in the processes and flowcharts in the illustrative embodiment basically indicates processing by the CPU 11 according to the instructions described in the auxiliary programs 42 and other programs. The processing by the CPU 11 includes hardware control using an API (“API” is an abbreviation for “Application Programming Interface”) of the OS 21. In the present disclosure, the operations by the individual programs may be described without a detailed explanation of the OS 21. In addition, “obtaining” and “acquiring” may be used as concepts that do not necessarily require a request.

At the beginning of the procedure, a user activates the information application 43 (A01). The information application 43 displays an information screen containing various types of information on the display 13a in response to a user's instruction (A02). If the user wishes to print an image of the information screen being displayed, the user selects “Print” on the information screen (A03). The information application 43 then sends a display request along with data of the information screen to the general-purpose print program 41 in the OS 21 (A04).

The general-purpose print program 41 displays a print setting screen on the display 13a in response to the display request (A06). The print setting screen is configured to accept instructions for print settings and a print execution instruction. For instance, as shown in FIG. 3, the print setting screen D2 includes a printer selection field 51, a notification field 52, a print setting field 53, a preview filed 54, a detailed setting button SW2, and a print button SW3. The printer selection field 51 is configured to accept selection of a printer. The notification field 52 is configured to display a notification image. The print setting field 53 is configured to accept designations of various print settings. The preview field 54 is configured to display a preview of an image (i.e., a print target image) of the information screen. The detailed setting button SW2 is configured to accept instructions for detailed print settings. The print button SW3 is configured to accept a print execution instruction.

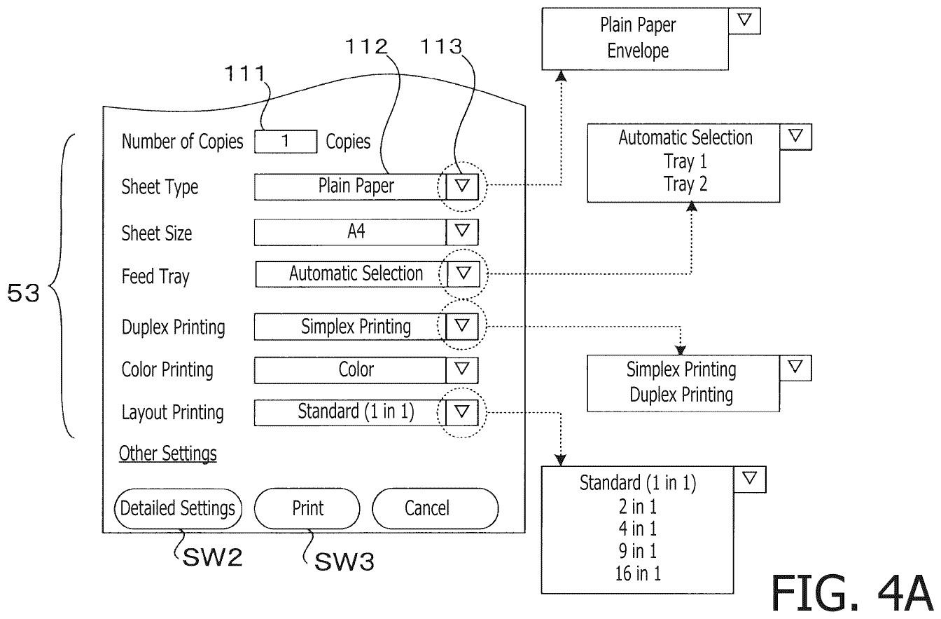

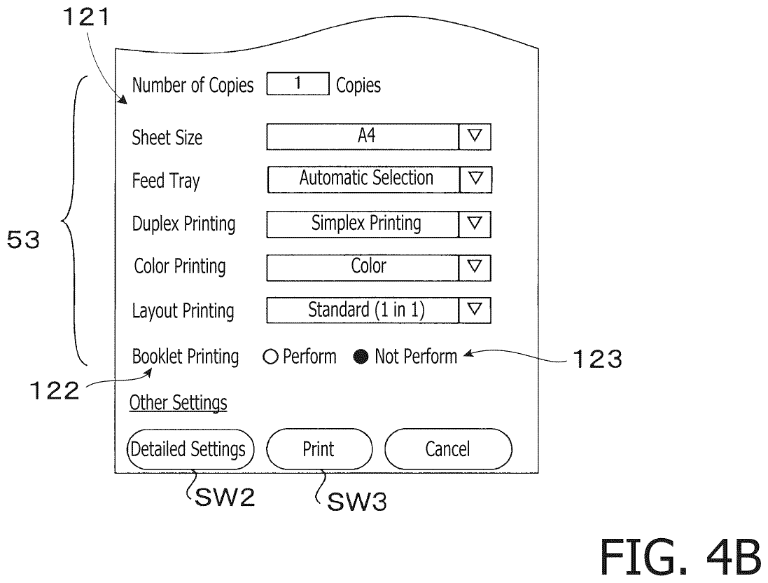

In the print setting field 53, the general-purpose print program 41 is enabled to display print setting items and accept settings of parameters. When the general-purpose print program 41 has not requested the auxiliary programs 42 to perform processing, the print setting field 53 displays print setting items and parameters for the print settings supported by the general-purpose print program 41. For instance, FIG. 4A shows an example of the print setting field 53 displayed when the general-purpose print program 41 has not requested the auxiliary programs 42 to perform processing. In the print setting field 53, each item has a setting field 111 and a list box 112. Each list box 112 is configured to, when a list button 113 is operated, display selectable parameters supported by the general-purpose print program 41 for a corresponding item.

Referring back to FIG. 3, the notification field 52 displays notification information received from the auxiliary programs 42. Based on the information received from the auxiliary programs 42, the general-purpose print program 41 may display an image in the notification field 52 or stop displaying an image.

As shown in FIG. 2, the user is allowed to select a printer by performing an operation on the printer selection field 51 on the print setting screen D2 being displayed (A07). When the printer 2 is selected, the general-purpose print program 41 activates the auxiliary programs 42 compatible with the printer 2 and sends to the auxiliary programs 42 a processing request for processing according to the selection of the printer 2 (A08). In A08, the general-purpose print program 41 passes information on the selected printer 2 and information on the print settings as set at the time of printer selection to the auxiliary programs 42.

When the printer 2 is set as a normally-used printer in the OS 21, for instance, as shown in FIG. 3, the general-purpose print program 41 displays the print setting screen D2 with the printer 2 selected (A06) and activates the auxiliary programs 42 (A08). Namely, the printer 2 is automatically selected by the OS 21, and the general-purpose print program 41 executes A08 based on the information on the selected printer 2. In this case, the user operation in A07 is unnecessary.

Instead of the general-purpose print program 41 displaying the print setting screen D2, the information application 43 may be configured to display the print setting screen D2. In such a case, the information application 43 may activate the general-purpose print program 41 in response to “Print” being selected in A03, obtain data to be displayed on the print setting screen D2 from the general-purpose print program 41, and display the print setting screen D2 on the display 13a. Then, the information application 43 may pass the information on the selected printer 2 to the general-purpose print program 41 in response to the printer 2 having already been selected, or in response to the printer 2 being selected in A07. Thereby, the general-purpose print program 41 activates the auxiliary programs 42 compatible with the printer 2 in A08.

The auxiliary programs 42, in response to being activated, sends a request for capability information of the printer 2 to the OS 21 (A11). In response to the request from the auxiliary programs 42, the OS 21 sends an obtainment request for the capability information to the printer 2, and obtains the capability information from the printer 2 (A12). The OS 21 passes the capability information obtained from the printer 2 to the auxiliary programs 42 (A13).

For instance, the OS 21 performs communication according to IPP (“IPP” is an abbreviation for “Internet Printing Protocol”) with the printer 2. Instead of sending the request to the OS 21, for instance, the auxiliary programs 42 may directly obtain the capability information from the printer 2 using MIB (“MIB” is an abbreviation for “Management Information Base”).

The capability information obtained from the printer 2 includes information on parameters that are settable as print settings. The capability information further includes information indicating an appropriate combination of print settings. The capability information further includes, for instance, status information, information on remaining amounts of consumables, information on attached trays, sheet information on sheets set for each tray, and information on supported print resolutions. The printer 2 may have functions to perform image processing based on a received print job and perform printing based on data obtained after the image processing, e.g., functions to perform aggregate printing such as N in 1, composition printing such as printing an image combined with a watermark, and saving printing to save colorant. When the printer 2 has image processing functions executable thereon, the printer 2 may pass information on the image processing functions to the OS 21 as capability information.

The auxiliary programs 42 store the capability information obtained from the OS21 in A13 in a particular area in the memory 12 that is usable by the auxiliary programs 42 (A14). When the capability information has already been stored in the memory 12, the auxiliary programs 42 overwrite the stored capability information and store the new capability information.

As shown in FIG. 2, the auxiliary programs 42 read the configuration file 45 (A20).

For instance, in the illustrative embodiment, a file name of the configuration file 45 and a storage area to store the configuration file 45 are previously determined, and the auxiliary programs 42 access the storage area and read the configuration file 45 based on the previously determined file name. In another instance, a path of the configuration file 45 may be registered in the auxiliary programs 42. In this case, the auxiliary programs 42 may access the configuration file 45 and read the configuration file 45 based on the registered path. The configuration file 45 may be stored in the memory 12 of the PC 1 or in an external device (e.g., a server) provided outside the PC 1.

The auxiliary programs 42, which have read the configuration file 45, perform a display data generation process (A21). The display data generation process is a process to generate display data based on the settings indicated by the setting data in the configuration file 45 read in A20. The display data is data indicating what is displayed on the print setting screen D2 (see FIG. 3).

The setting data in the configuration file 45 includes the settings configured by the user, the vendor of the printer 2, or the administrator of the printer 2 (hereinafter referred to as the “administrator, etc.”) to customize the display of the print setting screen D2. Examples of the setting data may include, but are not limited to, print setting items, parameters, and image data. The contents configured as the setting data are registered in a registration process. The registration process will be described later.

The display contents indicated by the display data include, for instance, the print setting items displayed in the print setting field 53 in FIG. 3, the parameters settable for each item, and notification images to be displayed in the notification field 52. Examples of the notification images may include, but are not limited to, text, a still image, a video, and a combination of at least two selected therefrom. The display contents may include an instruction to hide the notification field 52.

Furthermore, the auxiliary programs 42 pass display information including the generated display data to the general-purpose print program 41 (A22). Then, the processing by the auxiliary programs 42 in FIG. 2 is terminated. Based on the display information received from the auxiliary programs 42, the general-purpose print program 41 displays the notification field 52 and the print setting field 53 of the print setting screen D2 on the display 13a (A23). It is noted that the information application 43 may perform the process of A23 to display the print setting screen D2. In this case, the information application 43 may receive the display data and control the display contents of the notification field 52 and the print setting field 53.

When the display data includes items and parameters that are different from the print setting items and the parameters therefor supported by the general-purpose print program 41, the contents displayed in the print setting field 53 or the notification field 52 shown in FIG. 4A are changed, for instance, as shown in FIG. 4B, 5A, 5B, 6A, 6B or 7 depending on the configured settings. The customization of the print setting screen will be described in detail later. If the printer 2 is already selected when “Print” is selected in A03, the processes of A06 and A07 in FIG. 2 may be omitted. In this case, a customized print setting screen D2 may be displayed.

The following is a specific explanation of the customization of the print setting screen D2. First, a first specific example of customizing items to be displayed on the print setting screen D2 is described. Suppose for instance that the setting data includes a setting to not display a print setting item “Sheet Type.” Further, suppose for instance that the setting data includes settings for displaying “Booklet Printing” that is a setting item specific to the auxiliary programs 42 or the printer 2 and for displaying “Perform” and “Not Perform” as parameters for “Booklet Printing.”

In this case, the auxiliary programs 42 do not display the print setting item “Sheet Type” and the parameters for “Sheet Type,” but generate display data to display the item “Booklet Printing” and the parameters for “Booklet Printing” and pass the generated display data to the general-purpose print program 41, thereby causing the general-purpose print program 41 to display the item “Booklet Printing” and the parameters for “Booklet Printing.” As shown in FIG. 4A, the print setting item “Sheet Type” and the list box 112 therefor were displayed in the print setting field 53 before the change. However, as indicated by an arrow 121 in FIG. 4B, the print setting item “Sheet Type” and the list box 112 therefor are no longer displayed in the changed print setting field 53. Further, as indicated by arrows 122 and 123 in FIG. 4B, the item “Booklet Printing” and the parameters “Perform” and “Not Perform” therefor, which were not displayed in the print setting field 53 before the change, are additionally displayed in the changed print setting field 53.

Thus, the auxiliary programs 42 are enabled to increase or decrease the number of items configurable on the print setting screen D2 by customizing the print setting items displayed on the print setting screen D2. Thereby, it is possible to customize the operation of the printer 2.

A second specific example of customizing parameters to be displayed on the print setting screen D2 is described below. Suppose for instance that the setting data includes a setting to limit a range of “Number of Copies” to “equal to or more than 1 copy and equal to or less than 10 copies.” Further, suppose for instance that the setting data includes a setting to add “Cloth” as a parameter for “Sheet Type.” Further, suppose for instance that the setting data includes a setting to limit the parameter(s) settable for the item “Duplex Printing” to “Duplex Printing.” Further, suppose for instance that the setting data includes a setting to limit the parameter(s) settable for the item “Color” to “Monochrome.” Further, suppose for instance that the setting data includes a setting to limit the parameter(s) settable for the item “Layout Printing” to “Standard (1 in 1)” and “2 in 1.”

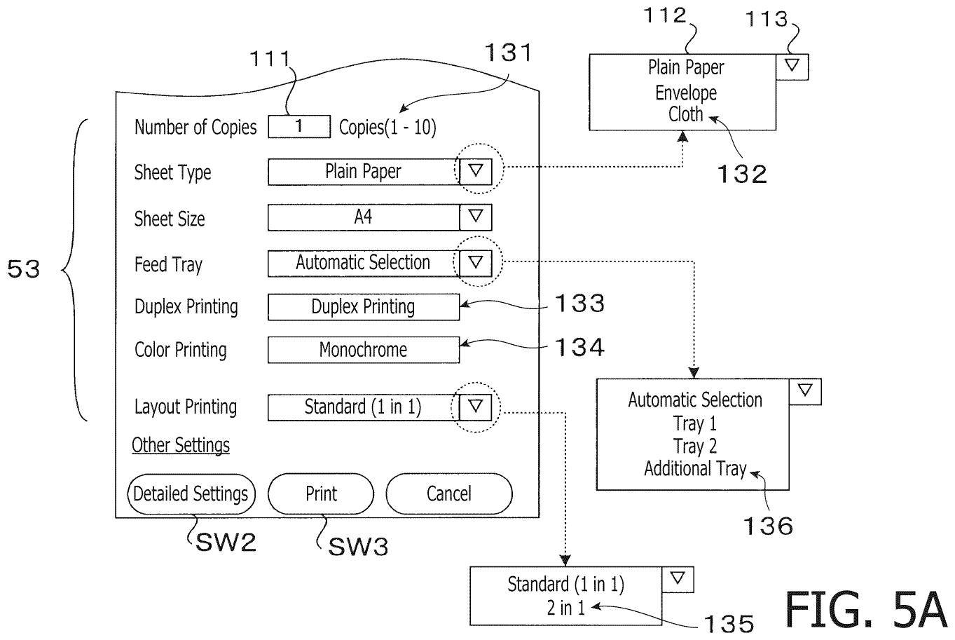

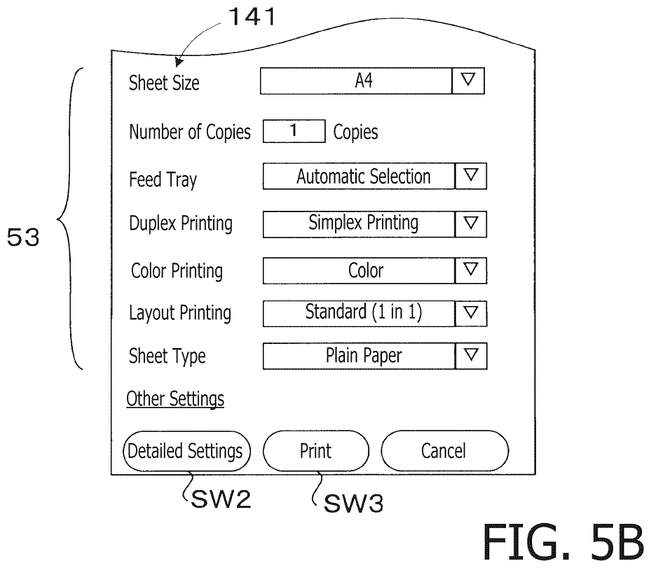

In this case, the auxiliary programs 42 generate display data to change, as indicated by arrows 131 to 136 in FIG. 5A, the parameters for the items “Number of Copies,” “Sheet Type,” “Duplex Printing,” “Color Printing,” and “Layout Printing” displayed on the print setting screen D2 (see FIG. 4A), and pass the generated display data to the general-purpose print program 41, thereby causing the general-purpose print program 41 to display the changed parameters.

For instance, on the print setting screen D2 (see FIG. 4A) before the change, no limits on the range of “Number of Copies” were displayed. However, as indicated by the arrow 131 in FIG. 5A, on the changed print setting screen D2, “1-10” representing a range of values settable for the number of copies is displayed next to the setting field 111 for “Number of Copies.” In this case, the general-purpose print program 41 does not accept values other than 1 to 10 in the setting field 111.

For instance, on the print setting screen D2 (see FIG. 4A) before the change, “Plain Paper” and “Envelope” were displayed as selectable in the list box 112 for “Sheet Type.” However, as indicated by the arrow 132 in FIG. 5A, on the changed print setting screen D2, “Cloth” is additionally displayed in the list box 112 for “Sheet Type.” Therefore, the user is allowed to cause the general-purpose print program 41 to display the parameters specific to the auxiliary programs 42 or the printer 2 on the print setting screen D2 and accept settings without causing the auxiliary programs 42 to display the detailed setting screen by operating the detailed setting button SW2 on the print setting screen D2.

For instance, on the print setting screen D2 (see FIG. 4A) before the change, “Simplex Printing” and “Duplex Printing” were displayed as selectable in the list box 112 for “Duplex Printing.” However, as indicated by the arrow 133 in FIG. 5A, on the changed print setting screen D2, only the parameter “Duplex Printing” is displayed for the item “Duplex Printing.” The item “Duplex Printing” has no list button. Thereby, since only “Duplex Printing” is settable as a parameter for the item “Duplex Printing,” it is possible to achieve the same operation for the item “Duplex Printing” in any printing. On the print setting screen D2 (see FIG. 4A) before the change, “Color” and “Monochrome” were displayed as selectable in the list box 112 for “Color Printing.” However, as indicated by the arrow 134 in FIG. 5A, on the changed print setting screen D2, only the parameter “Monochrome” is displayed for the item “Color Printing.”

For instance, on the print setting screen D2 (see FIG. 4A) before the change, “Standard (1 in 1),” “2 in 1,” “4 in 1,” “9 in 1,” and “16 in 1” “were displayed as selectable in the list box 112 for “Layout Printing.” However, as indicated by the arrow 135 in FIG. 5A, on the changed print setting screen D2, only “Standard (1 in 1)” and “2 in 1” are displayed in the list box 112 for “Layout Printing,” and “4 in 1,” “9 in 1,” and “16 in 1” are not displayed. Thereby, it is possible to achieve such an operation that the use of some parameters (e.g., “4 in 1,” “9 in 1,” and “16 in 1”) of the parameters settable for the item “Layout Printing” by the general-purpose print program 41 is restricted.

For instance, in the illustrative embodiment, the particular print setting items and/or parameters for which settings are not configurable are not displayed to render unacceptable the settings for the particular print setting items and/or parameters. In another instance, the particular print setting items and/or parameters for which settings are not configurable may be grayed out to render unacceptable the settings for the particular print setting items and/or parameters. This allows the user to recognize which items or parameters are restricted for use and to become aware of the functions of the auxiliary programs 42 or the printer 2.

In the meantime, if the printer 2 is configured to accept an additional tray detachably attached, the setting data may include “Additional Tray” as a parameter settable for the item “Feed Tray.” If the auxiliary programs 42 generate display data based solely on this setting data, regardless of whether an additional tray is attached to the printer 2, the print setting screen D2 will additionally display “Additional Tray” in the list box 112 for “Feed Tray,” as indicated by an arrow 136 in FIG. 5A. If “Additional Tray” is set for “Feed Tray” on the print setting screen D2 shown in FIG. 5A in a case where an additional tray is not attached to the printer 2 when the printer 2 is selected, it results in an increased possibility of a print failure.

Therefore, the auxiliary programs 42 may generate display data by comparing the setting data with the capability information obtained from the printer 2 in A21 of FIG. 2. If an additional tray is not attached to the printer 2, the capability information obtained from the printer 2 does not include “Additional Tray” as a parameter settable for “Feed Tray.” Based on the setting data and the capability information, the auxiliary programs 42 generate display data to not additionally display “Additional Tray” in the list box 112 for “Feed Tray.” On the print setting screen D2 displayed based on the display data generated as above, “Additional Tray” is not displayed in the list box 112 for “Feed Tray.” Therefore, when printing is performed by specifying the printer 2 without an additional tray attached, “Additional Tray” is not set for “Feed Tray.” Thus, it is possible to prevent a print failure due to an incorrect setting as described above.

A third specific example of customizing the display order of items on the print setting screen D2 is described below. Suppose for instance that the setting data includes a setting to place “Sheet Size” at the top of the list of the print setting items. In this case, the auxiliary programs 42 generate display data to display the items as arranged with “Sheet Size” at the top, and pass the generated display data to the general-purpose print program 41. As shown in FIG. 4A, “Sheet Size” was displayed third from the top on the print setting screen D2 before the change. However, as indicated by an arrow 141 in FIG. 5B, “Sheet Size” is displayed at the top on the changed print setting screen D2.

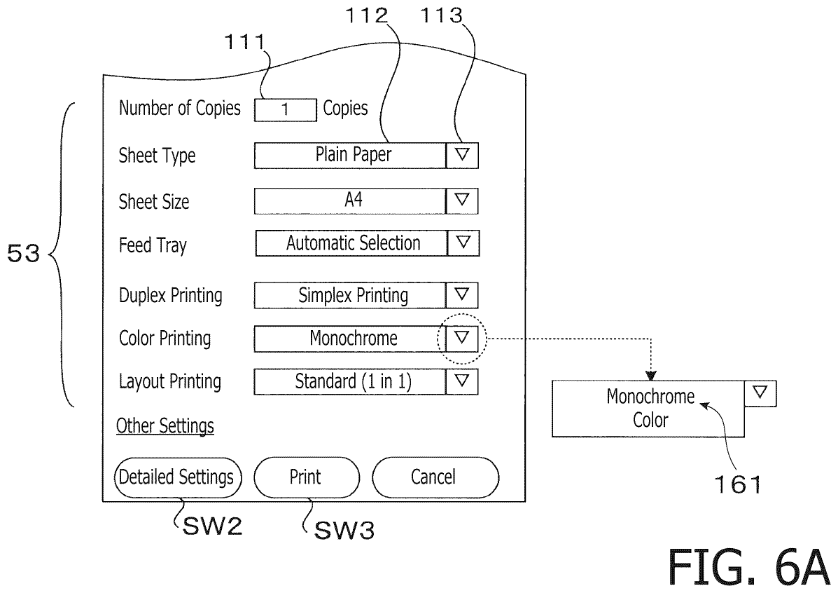

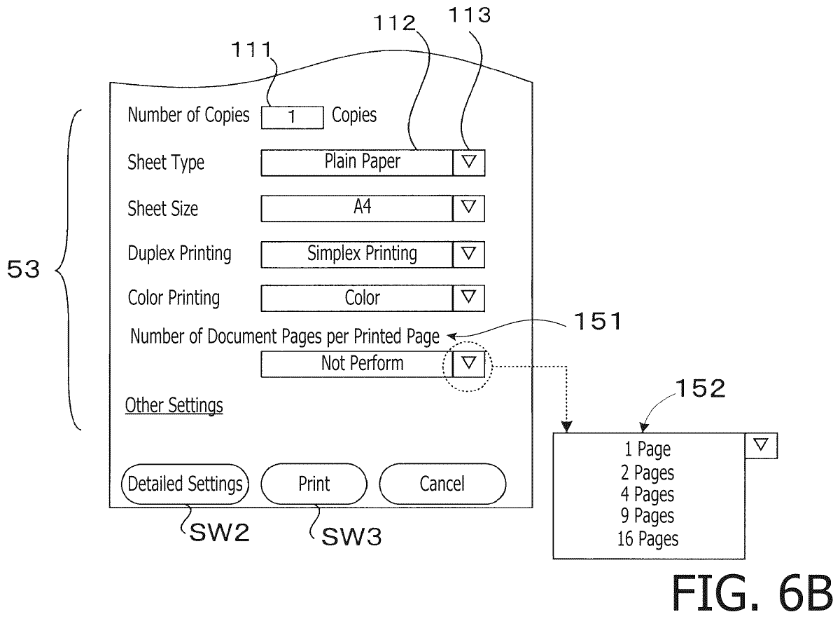

A fourth specific example of customizing the display order of parameters settable for an item is described below. Suppose for instance that the setting data includes a setting to display “Monochrome” first and “Color” second from the top of the listed parameters settable for “Color Printing.” In this case, the auxiliary programs 42 generate display data to display “Monochrome” first and “Color” second in the list box 112 for “Color Printing,” and pass the generated display data to the general-purpose print program 41. As shown in FIG. 4A, “Color” and “Monochrome” were displayed in this order from the top in the list box 112 for “Color Printing” on the print setting screen D2 before the change. However, as indicated by an arrow 161 in FIG. 6A, “Monochrome” and “Color” are displayed in this order from the top in the list box 112 for “Color Printing” on the changed print setting screen D2.

A fifth specific example of customizing the notation (i.e., how an item and parameters for the item are represented) on the print setting screen D2 is described below. Suppose for instance that the setting data includes a setting to change the notation of “Layout Printing” to “Number of Document Pages per Printed Page” and change the respective notation of the parameters “Standard (1 in 1),” “2 in 1,” “4 in 1,” “9 in 1,” and “16 in 1” for “Layout Printing” to “1 Sheet,” “2 Sheets,” “4 Sheets,” “9 Sheets,” and “16 Sheets.” In this case, the auxiliary programs 42 generate display data to display an item “Number of Document Pages per Printed Page” and to display parameters “1 Sheet,” “2 Sheets,” “4 Sheets,” “9 Sheets,” and “16 Sheets” in a list box 112 for “Number of Document Pages per Printed Page,” and pass the generated display data to the general-purpose print program 41. The generated display data includes none of the item name of “Layout Printing” and the parameter names of “Standard (1 in 1),” “2 in 1,” “4 in 1,” “9 in 1,” and “16 in 1.”

Thereby, the notation of the item “Layout Printing” displayed on the print setting screen D2 before the change as shown in FIG. 4A is changed to “Number of Document Pages per Printed Page,” as indicated by an arrow 151 in FIG. 6B, on the changed print setting screen D2. In addition, the respective notation of the parameters “Standard (1 in 1),” “2 in 1,” “4 in 1,” “9 in 1,” and “16 in 1” for “Layout Printing” in FIG. 4A is changed to “1 Sheet,” “2 Sheets,” “4 Sheets,” “9 Sheets,” and “16 Sheets,” as indicated by an arrow 152 in FIG. 6B. Thus, for instance, the notation of each item and each parameter on the print setting screen D2 may be changed to a specific notation for the auxiliary programs 42 or the printer 2, or may be changed to wording that makes it easier to imagine what the notation of each item and each parameter represents. Thereby, it is possible to improve the usability of the print setting screen D2.

A sixth specific example of customizing a language used for the print setting screen D2 is described below. For instance, when the language used in the OS 21 is set to Chinese, the print setting screen D2 displayed by the general-purpose print program 41 is displayed in Chinese. For instance, when the setting data includes a setting in which the language used is “Japanese,” the auxiliary programs 42 generate display data in Japanese and pass the generated display data to the general-purpose print program 41. The general-purpose print program 41 displays the received display data in Japanese on the print setting screen D2. Namely, the language used for the print setting screen D2 is changed from “Chinese” to “Japanese.”

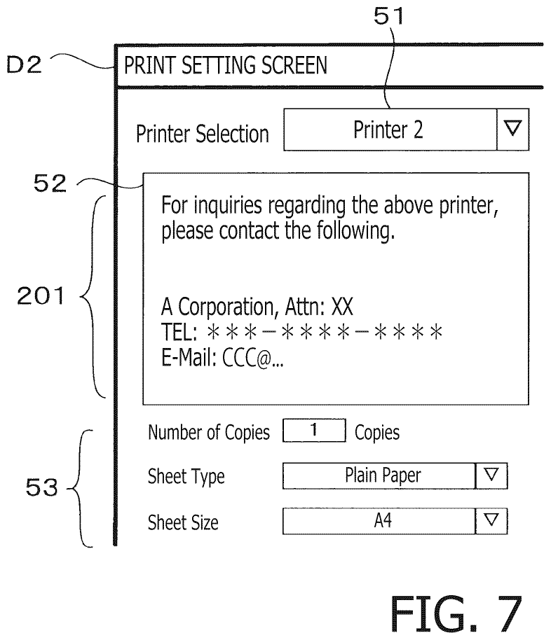

A seventh specific example of customizing an image to be displayed on the print setting screen D2 is described below. Suppose for instance that the setting data includes image data representing contact information of the vendor of the printer 2. In this case, the auxiliary programs 42 generate display data to display the image data in the notification field 52 and pass the generated display data to the general-purpose print program 41. Thereby, as indicated by a reference numeral 201 in FIG. 7, a notification image is displayed to provide the contact information of the vendor of the printer 2 in the notification field 52 on the print setting screen D2. Thus, when a problem has occurred, the user may immediately reach the contact displayed in the notification field 52 to address the problem.

An eighth specific example of customizing the notification field 52 of the print setting screen D2 to display nothing therein is described below. For instance, the auxiliary programs 42 generate display data to display no image in the notification field 52 and pass the generated display data to the general-purpose print program 41. In this case, nothing is displayed in the notification field 52 on the print setting screen D2. In this case, the notification field 52 itself may be deleted.

FIG. 3 shows an example of the print setting screen D2 having a single notification field 52. However, practicable examples of the features (e.g., the location, the shape, the size, and the count) of the notification field(s) 52 are not limited to the example shown in FIG. 3. The auxiliary programs 42 may obtain information on the notification field 52 from the general-purpose print program 41 and determine notification data to be displayed in the notification field 52 based on the obtained information. For instance, when there are a plurality of locations where the notification field 52 is allowed to be displayed, and the auxiliary programs 42 are enabled to specify a display location for the notification field 52 from among the plurality of locations, the auxiliary programs 42 may pass notification data that includes information specifying the display location to the general-purpose print program 41. In addition, when the auxiliary programs 42 are enabled to select a size of the notification field 52, the auxiliary programs 42 may pass information specifying the size of the notification field 52 to the general-purpose print program 41.

Instead of generating display data and passing the generated display data to the general-purpose print program 41, the auxiliary programs 42 may display information themselves. In this case, however, the auxiliary programs 42 need to display a screen separate from the print setting screen D2. When the information is displayed on the print setting screen D2 displayed by the general-purpose print program 41 of the OS 21, it is possible to simplify the display and reduce the user's stress.

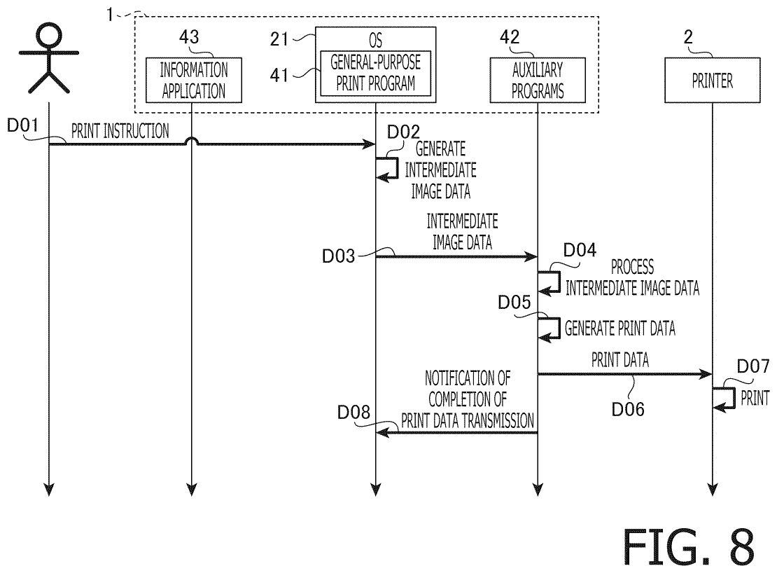

Next, an explanation will be given of procedures by the individual programs when a print execution instruction input by a user operation to the print button SW3 has been received while the print setting screen D2 shown in FIG. 4 is being displayed, with reference to a sequence chart in FIG. 8. The print execution instruction may be input by the user directly to the general-purpose print program 41, or may be input to the information application 43 and output from the information application 43 to the general-purpose print program 41. It is noted that, in the present disclosure, the print execution instruction may be referred to as the “print instruction.”

In response to receiving the user instruction to execute printing (D01), the general-purpose print program 41 generates intermediate image data by converting a format of image data representing a target image to be printed into a format of intermediate image data using the print settings accepted on the print setting screen D2 (D02), and then passes the generated intermediate image data to the auxiliary programs 42 (D03). The information application 43 includes various types of image data. The general-purpose print program 41 converts the image data to be printed into intermediate image data suitable for generating print data. If the image data to be printed is suitable for generating print data, generating the intermediate image data may be omitted. In this case, the image data to be printed may be used as intermediate image data. The intermediate image data is, for instance, XPS data.

The auxiliary programs 42 reflect the print settings configured in the auxiliary programs 42 in the intermediate image data received in D03, and thus process the intermediate image data (D04). The auxiliary programs 42 rasterize the processed intermediate image data to generate print data representing the target image to be printed (D05). The print data generated in D05 is data (e.g., PDL data) in a format usable for printing by the printer 2.

When the processed intermediate image data is rasterized by the auxiliary programs 42 compatible with the printer 2, the rasterization is achieved with a higher degree of freedom and it is more likely that print data suitable for printing by the printer 2 is generated than when rasterized by the general-purpose print program 41. The print data generated by the auxiliary programs 42 may be in a format specific to the model of the printer 2.

The auxiliary programs 42 transmit the print data generated in D05 to the printer 2 together with a print command for instructing the printer 2 to perform printing (D06). When there is image processing that has been determined to be performed by the printer 2, the auxiliary programs 42 generate a print command that includes information on the image processing. The auxiliary programs 42 may further provide a notification that the transmission of the print data has been completed to the general-purpose print program 41 (D08). The notification may include an instruction to cancel the transmission of the print data by the general-purpose print program 41.

The printer 2, which has received the print data and the print command, performs printing of the target image represented by the print data based on the received print command (D07). Thus, a printed material is generated.

Instead of the auxiliary programs 42 generating the print data, the general-purpose print program 41 may generate the print data. For instance, the auxiliary programs 42 may pass the intermediate image data processed in D04 and information on printing to be executed to the general-purpose print program 41. Then, the general-purpose print program 41 may rasterize the processed intermediate image data to generate the print data. In this case, the general-purpose print program 41 may pass the generated print data to the auxiliary programs 42. In response to receiving the print data from the general-purpose print program 41, the auxiliary programs 42 send the received print data to the printer 2 together with the print command for instructing the printer to perform printing.

The print data generated by the general-purpose print program 41 is print data (e.g., PWG Raster data or PDF data) in a format usable for printing by various types of printers. If rasterization is performed by the general-purpose print program 41, it results in a smaller amount of processing by the auxiliary programs 42, thereby avoiding an increase in processing time, and reducing a program size of the auxiliary programs 42.

The general-purpose print program 41 may send the print data and the print command to the printer 2. Namely, the auxiliary programs 42 may pass the generated print data to the general-purpose print program 41, to be sent from the PC 1 with the printer 2 as a destination. In such a case, the general-purpose print program 41 may send the print data received from the auxiliary programs 42 to the printer 2.

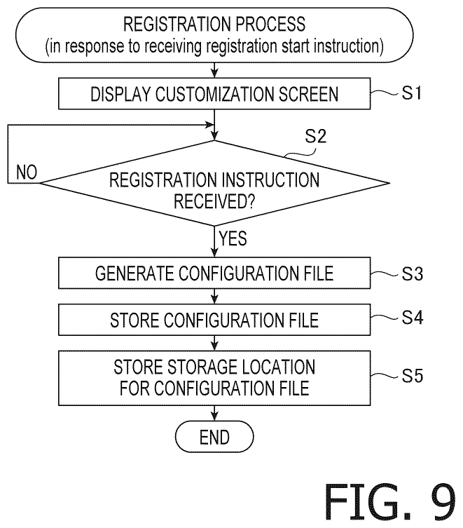

Next, a procedure of the aforementioned registration process will be described with reference to a flowchart in FIG. 9. Here, an explanation is given of a case in which the registration process is performed using the auxiliary programs 42. For instance, the administrator activates the auxiliary programs 42 using the user I/F 13 and inputs a registration start instruction. In response to receiving the registration start instruction, the CPU 11 performs the registration process shown in FIG. 9.

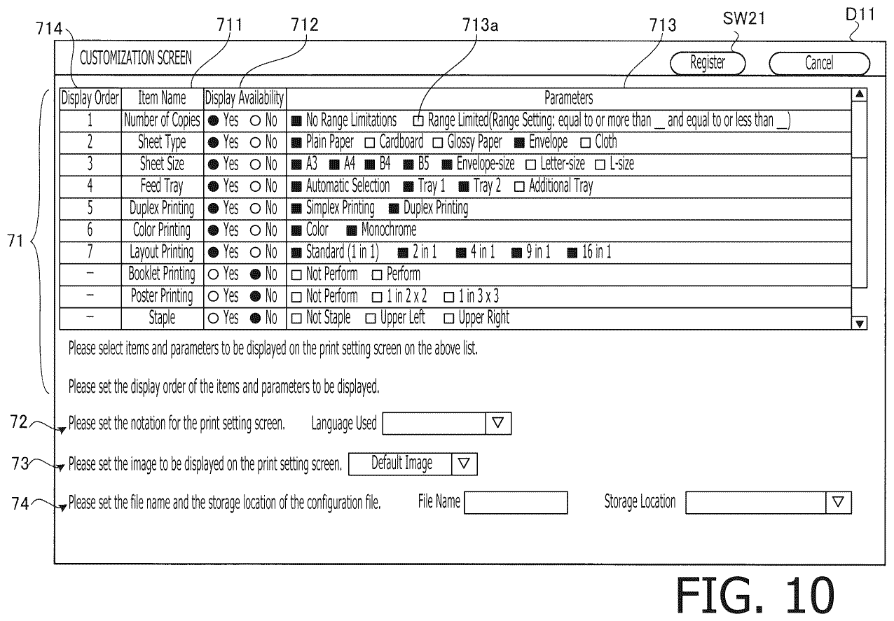

The CPU 11 first displays, on the display 13a of the PC 1, a customization screen to accept contents of customization (S1). FIG. 10 shows an example of the customization screen. For instance, the customization screen D11 shown in FIG. 10 includes a print setting customization area 71, a notation customization area 72, a notification image customization area 73, a storage location setting area 74, and a registration button SW21.

The print setting customization area 71 is an area for customizing print setting items and parameters therefor to be displayed on the print setting screen D2. For instance, the print setting customization area 71 has an item name display field 711, a display availability selection field 712, a parameter selection field 713, and check boxes 713a. The item name display field 711 and the parameter selection field 713 are configured to display items and parameters that are settable by the auxiliary programs 42. Namely, target functions to be customized on the customization screen D11 may include functions achieved by the auxiliary programs 42 and/or functions specific to the printer 2. The item names displayed in the item name display field 711 may be edited by double-clicking them.

The display availability selection field 712 is provided for each item and configured to set whether each item is to be displayed on the print setting screen D2. Items for which “Yes” is set in the display availability selection field 712 are displayed on the print setting screen D2. Meanwhile, items for which “No” is set in the display availability selection field 712 are not displayed on the print setting screen D2. The check box 713a is provided for each parameter and configured to set whether each parameter is to be displayed on the print setting screen D2. Parameters for which the check boxes 713a are checked are displayed on the print setting screen D2. Meanwhile, parameters for which the check boxes 713a are not checked are not displayed on the print setting screen D2.

The print setting customization area 71 includes a display order setting field 714 for setting a display order of the items to be displayed on the print setting screen D2. The display order setting field 714 is configured to accept an input of a display order for each of the items for which “Yes” has been set in the display availability selection field 712.

For instance, the parameters for each item in the parameter selection field 713 are displayed in the list box 112 for each item on the print setting screen D2 in the same order as a display order in which the parameters are displayed in the parameter selection field 713. The parameters displayed in the parameter selection field 713 may be reordered, for instance, by dragging. Thereby, it is possible to change the order of the parameters to be displayed in the list box 112 for each item on the print setting screen D2. In addition, by double-clicking on a parameter of which the name is to be changed, the name of the parameter may be edited.

On the customization screen D11, a setting field for setting the display order may be provided separately from the print setting customization area 71. The print setting customization area 71 may reflect the print settings (e.g., the items, the parameters, and display order) that are set in the general-purpose print program 41. The items and the parameters in the print settings that are configurable by the general-purpose print program 41 may be displayed in such a manner that they are distinguished from items and parameters that are unconfigurable by the general-purpose print program 41.

The notation customization area 72 is an area for setting the notation for the print setting screen D2. Examples of items settable as the notation for the print setting screen D2 may include, but are not limited to, the language and wording used for the print setting screen D2. A parameter for each notation item may be selected from a plurality of options or may be entered manually.

The notification image customization area 73 is an area for setting an image to be displayed in the notification field 52 on the print setting screen D2. Examples of images settable to be displayed in the notification field 52 may include, but are not limited to, a default image and optional images. For instance, the default image may be a printer manufacturer's logo. Examples of the optional images may include, but are not limited to, an image of an advertisement, a link to display the advertisement, and contact information. The optional images may be set arbitrarily. The notification image customization area 73 may accept a setting to not display an image in the notification field 52.

The storage location setting area 74 is an area for setting a file name and a storage location of the configuration file 45. When the file name and the storage location of the configuration file 45 are previously determined, the previously determined file name and storage location may be displayed in the storage location setting area 74 as fixed values, or the storage location setting area 74 may not be displayed. Meanwhile, when the file name and the storage location of the configuration file 45 are not previously determined, the user may arbitrarily set the file name and the storage location via the storage location setting area 74. In this case, a path of the configuration file 45 may be registered in the auxiliary programs 42. Examples of the storage location of the configuration file 45 are not limited to the PC 1, but may include an external server.

Referring back to FIG. 9, in response to the registration button SW21 on the customization screen D11 being operated using the user I/F 13, the CPU 11 displaying the customization screen D11 determines that a registration instruction has been received (S2: Yes) and generates the configuration file 45 (S3). Namely, the CPU 11 generates a file containing setting data accepted via the customization screen D11.

The CPU 11 gives the generated configuration file 45 a file name set in the storage location setting area 74 on the customization screen D11 and stores the configuration file 45 in the storage location set in the storage location setting area 74 on the customization screen D11 (S4). Further, the CPU 11 stores the file name and the storage location that are set in the storage location setting area 74 on the customization screen D11 (S5). Thereafter, CPU 11 terminates the registration process.

As described above, in response to receiving a processing request from the general-purpose print program 41 when the printer 2 is selected, the auxiliary programs 42 read the configuration file 45 for customizing the print setting screen D2 and pass the display data reflecting the settings indicated in the configuration file 45 to the general-purpose print program 41. The general-purpose print program 41 is an OS-standard print program that is different from a printer driver for each model of the printer 2. The general-purpose print program 41 displays the print setting screen D2 on the display 13a of the PC 1 according to the display data received from the auxiliary programs 42. This allows the PC 1, which uses the OS-standard general-purpose print program 41, to display on the display 13a the print setting screen D2 that suits the user's preference and the specifications and/or the operation of the printer 2.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

For instance, devices and apparatuses connected with the PC 1 are not limited to printers, but may be any devices (e.g., multi-function peripherals, copiers, and fax machines) having a printing function. The number of printers connected with the PC 1 is not limited to the example (i.e., one) shown in the relevant drawings, but may be two or more.

For instance, the auxiliary programs 42 may not necessarily generate display data including items (e.g., Booklet Printing) or parameters (e.g., Cloth) specific to the auxiliary programs 42 or the printer 2. However, when the auxiliary programs 42 generate display data including specific items and specific parameters, it is possible to add new items (e.g., Booklet Printing) and new parameters (e.g., Cloth) to the print setting screen D2, as shown in FIGS. 4B and 5A. This allows the auxiliary programs 42 or the printer 2 to perform specific processing corresponding to the added items or parameters.

For instance, the auxiliary programs 42 may not necessarily change the display order of the items or the parameters to be displayed on the print setting screen D2. However, when the auxiliary programs 42 generate display data including the display order, it is possible, for instance, to display items or parameters that are changed more frequently by the user ahead of items or parameters that are changed less frequently in the display order, as shown in FIG. 5B. This makes it easier for the user to change the settings for the more frequently changed items or parameters, thereby improving convenience.

For instance, the auxiliary programs 42 may not necessarily change the notation on the print setting screen D2. However, when the auxiliary programs 42 change the notation, it is possible, for instance, to change a current notation on the print setting screen D2 to a notation in a user-understandable language. This makes it easier for the user to change the settings for the items or the parameters displayed on the print setting screen D2, thereby improving convenience.

For instance, the auxiliary programs 42 may not necessarily customize the image to be displayed in the notification field 52 on the print setting screen D2. However, when the auxiliary programs 42 customize the image to be displayed in the notification field 52, it is possible to achieve a higher degree of freedom for the image to be displayed on the print setting screen D2.

For instance, the auxiliary programs 42 may cause the notification field 52 on the print setting screen D2 to always display an image therein. However, when the auxiliary programs 42 cause the notification field 52 on the print setting screen D2 to not display an image therein, it is possible to achieve a higher degree of freedom in the display on the print setting screen D2. In addition, it is possible to avoid an unnecessary image from being displayed frequently in the notification field 52.

For instance, the registration process shown in FIG. 9 may be performed by a program other than the auxiliary programs 42. However, as in the aforementioned illustrative embodiment, when the auxiliary programs 42 (more specifically, the CPU 11 executing the auxiliary programs 42) perform the registration process, read the setting data in the configuration file 45 generated and stored in the registration process, and generate display data based on the read setting data, it is possible to achieve a higher degree of freedom for the setting data. In addition, it is possible to manage the setting data more easily. Furthermore, it is possible to customize the display on the print setting screen D2 by using the auxiliary programs 42 incorporated in the PC 1. Thus, it is possible to improve user-friendliness because it is not necessary to load another program into the PC 1 separately from the auxiliary programs 42 or to store setting data registered elsewhere in the PC 1 from an external storage device.

The general-purpose print program 41 may activate the auxiliary programs 42 when, after the print setting screen D2 is displayed by the general-purpose print program 41, the normally-used printer is changed from another printer to the printer 2 via the OS 21 by a user operation. In such a case as well, in substantially the same manner as when the printer 2 is selected, the auxiliary programs 42 may perform the display data generation process and pass the generated display data to the general-purpose print program 41.

In the aforementioned illustrative embodiment, only the printing operation has been described in detail as the operation by the auxiliary programs 42. However, the auxiliary programs 42 may further have other roles. Examples of the program to perform the processing in the aforementioned illustrative embodiment are not limited to the auxiliary programs 42, but may include any program configured to accept instructions from the OS 21 or the general-purpose print program 41 when printing is performed using the general-purpose print program 41. For instance, a print workflow application (Print workflow) whose specifications have been published by Microsoft Corp. may be included in the examples of the program to perform the processing in the aforementioned illustrative embodiment.

Practicable examples of the execution timing for executing the auxiliary programs 42 are not limited to the example in the aforementioned illustrative embodiment. For instance, the auxiliary programs 42 may be executed in response to a direct execution instruction from the OS 21. In another instance, the auxiliary programs 42 may be resident programs. In this case, the auxiliary programs 42 may perform the aforementioned operations in response to receiving execution commands.

In any flowchart disclosed in the aforementioned illustrative embodiment, a plurality of processes in a plurality of any steps may be arbitrarily changed in the execution order thereof or may be executed in parallel as long as there is no inconsistency in the processing results.

The processing disclosed in the aforementioned illustrative embodiment may be performed by one or more CPUs, one or more hardware elements such as ASICs, or a combination of at least two selected therefrom. The processing disclosed in the aforementioned illustrative embodiment may be implemented in various aspects such as a non-transitory computer-readable storage medium storing computer-readable instructions (e.g., programs) for performing the processing, or a method for performing the processing.

The following shows examples of associations between elements illustrated in the aforementioned illustrative embodiment(s) and modification(s), and elements claimed according to aspects of the present disclosure. For instance, the PC 1 may be an example of an “information processing device” according to aspects of the present disclosure. The CPU 11 may be an example of a “computer” according to aspects of the present disclosure. The memory 12 may be an example of a “non-transitory computer-readable storage medium” according to aspects of the present disclosure. The controller 10 may be an example of a “controller” according to aspects of the present disclosure. The display 13a may be an example of a “display” according to aspects of the present disclosure. The auxiliary programs 42 may be an example of “computer-readable instructions” according to aspects of the present disclosure. The general-purpose print program 41 may be an example of a “general-purpose print program” according to aspects of the present disclosure. The information application 43 may be an example of an “application program” according to aspects of the present disclosure. The notification field 52 may be an example of a “particular display area” according to aspects of the present disclosure. The setting data stored in the configuration file 45 may be an example of “setting data” according to aspects of the present disclosure. The configuration file 45 itself may be an example of the “setting data” according to aspects of the present disclosure. The item “Duplex Printing” may be an example of a “particular item” according to aspects of the present disclosure. The parameter “Duplex Printing” for the item “Duplex Printing” may be an example of a “particular parameter” according to aspects of the present disclosure. The item “Layout Printing” may be an example of a “specific item” according to aspects of the present disclosure. The parameters “4 in 1,” “9 in 1,” and “16 in 1” for the item “Layout Printing” may be included in examples of a “specific parameter” according to aspects of the present disclosure. The item “Booklet Printing” may be an example of an “additional item” according to aspects of the present disclosure. The item “Sheet Type” may be an example of a “specified item” according to aspects of the present disclosure. The parameter “Cloth” for the item “Sheet Type” may be an example of an “additional item” according to aspects of the present disclosure.

What is claimed is:

1. A non-transitory computer-readable storage medium storing computer-readable instructions that are executable by a computer of an information processing device and compatible with a printer connected with the information processing device, the instructions supporting a general-purpose print program incorporated in advance in an operating system of the information processing device, the instructions being configured to, when executed by the computer, cause the information processing device to:
read, in response to receiving a processing request from the general-purpose print program when the printer is selected, setting data indicating settings for customizing a print setting screen, the general-purpose print program being configured to, when executed by the computer, cause the information processing device to display the print setting screen on a display of the information processing device;
generate, based on the settings indicated by the read setting data, display data indicating contents to be displayed on the print setting screen; and
send the generated display data to the general-purpose print program, thereby causing the print setting screen to be displayed on the display in accordance with the display data via the general-purpose print program.

2. The non-transitory computer-readable storage medium according to claim 1,
wherein the instructions are further configured to, when executed by the computer, cause the information processing device to:
include, into the settings indicated by the setting data, one or more print setting items and/or one or more parameters settable for each print setting item; and
based on the setting data indicating the settings that include the one or more print setting items and/or the one or more parameters settable for each print setting item, generate the display data to specify, as contents to be displayed on the print setting screen, the one or more print setting items and/or the one or more parameters settable for each print setting item.

3. The non-transitory computer-readable storage medium according to claim 2,
wherein the instructions are further configured to, when executed by the computer, cause the information processing device to:
when the settings indicated by the setting data include a particular parameter set for a particular item of the one or more print setting items, generate the display data in which the particular parameter is set not to be changed to another parameter for the particular item of the one or more print setting items that are to be displayed on the print setting screen.

4. The non-transitory computer-readable storage medium according to claim 2,
wherein the instructions are further configured to, when executed by the computer, cause the information processing device to:
when the settings indicated by the setting data include a setting to preclude a specific parameter from being set for a specific item among a plurality of parameters settable for the specific item of the one or more print setting items, generate the display data to preclude the specific parameter from being set for the specific item of the one or more print setting items that are to be displayed on the print setting screen.

5. The non-transitory computer-readable storage medium according to claim 2,
wherein the instructions are further configured to, when executed by the computer, cause the information processing device to:
when the settings indicated by the setting data include a setting to incorporate an additional item into the one or more print setting items, generate the display data to render the additional item configurable in the one or more print setting items that are to be displayed on the print setting screen.

6. The non-transitory computer-readable storage medium according to claim 2,
wherein the instructions are further configured to, when executed by the computer, cause the information processing device to:
when the settings indicated by the setting data include a setting to incorporate an additional parameter as a parameter settable for a specified item of the one or more print setting items, generate the display data to render the additional parameter settable for the specified item of the one or more print setting items that are to be displayed on the print setting screen.

7. The non-transitory computer-readable storage medium according to claim 2,
wherein the instructions are further configured to, when executed by the computer, cause the information processing device to:
when the settings indicated by the setting data include a display order for each of the one or more print setting items and/or a display order for each of the one or more parameters settable for each print setting item, generate the display data to specify the display order for each of the one or more print setting items that are to be displayed on the print setting screen and/or the display order for each of the one or more parameters settable for each print setting item.

8. The non-transitory computer-readable storage medium according to claim 2,
wherein the instructions are further configured to, when executed by the computer, cause the information processing device to:
when the settings indicated by the setting data include a notation for each of the one or more print setting items and/or a notation for each of the one or more parameters settable for each print setting item, generate the display data to specify the notation for each of the one or more print setting items that are to be displayed on the print setting screen and/or the notation for each of the one or more parameters settable for each print setting item.

9. The non-transitory computer-readable storage medium according to claim 1,
wherein the print setting screen includes a particular display area configured to display an image, and
wherein the instructions are further configured to, when executed by the computer, cause the information processing device to:
when the settings indicated by the setting data include image data, generate the display data to display an image represented by the image data in the particular display area on the print setting screen.

10. The non-transitory computer-readable storage medium according to claim 1,
wherein the print setting screen includes a particular display area configured to display an image, and
wherein the instructions are further configured to, when executed by the computer, cause the information processing device to:
when the settings indicated by the setting data include information indicating that no image is to be displayed in the particular display area on the print setting screen, generate the display data to display no image in the particular display area on the print setting screen.

11. The non-transitory computer-readable storage medium according to claim 1,
wherein the instructions are further configured to, when executed by the computer, cause the information processing device to:
perform a registration process to register the setting data to be read; and
read, in said reading, the setting data registered in the registration process.

12. The non-transitory computer-readable storage medium according to claim 11,
wherein the instructions are further configured to, when executed by the computer, cause the information processing device to perform the registration process comprising:
displaying, on the display of the information processing device, a customization screen configured to accept the settings for customizing the print setting screen; and
registering the setting data based on the settings accepted via the customization screen.

13. The non-transitory computer-readable storage medium according to claim 1,
wherein the instructions are further configured to, when executed by the computer, cause the information processing device to:
in response to receiving a processing request from the general-purpose print program when a print instruction to cause the printer to print a target image has been output from an application program incorporated in the information processing device to the general-purpose print program, obtain image data representing the target image from the general-purpose print program, and send a print command to the printer based on the obtained image data.

14. An information processing device comprising:
a display; and
a controller comprising:
a computer; and
a non-transitory computer-readable storage medium storing a general-purpose print program incorporated in advance in an operating system of the information processing device, and computer-readable instructions that are compatible with a printer connected with the information processing device and support the general-purpose print program, the instructions being configured to, when executed by the computer, cause the controller to:
read, in response to receiving a processing request from the general-purpose print program when the printer is selected, setting data indicating settings for customizing a print setting screen, the general-purpose print program being configured to, when executed by the computer, cause the controller to display the print setting screen on the display;
generate, based on the settings indicated by the read setting data, display data indicating contents to be displayed on the print setting screen; and
send the generated display data to the general-purpose print program, thereby causing the print setting screen to be displayed on the display in accordance with the display data via the general-purpose print program.

15. A method implementable by a computer executing computer-readable instructions on an information processing device, the instructions being compatible with a printer connected with the information processing device and supporting a general-purpose print program incorporated in advance in an operating system of the information processing device, the method comprising:
reading, in response to receiving a processing request from the general-purpose print program when the printer is selected, setting data indicating settings for customizing a print setting screen, the general-purpose print program being configured to, when executed by the computer, cause the information processing device to display the print setting screen on a display of the information processing device;
generating, based on the settings indicated by the read setting data, display data indicating contents to be displayed on the print setting screen; and
sending the generated display data to the general-purpose print program, thereby causing the print setting screen to be displayed on the display in accordance with the display data via the general-purpose print program.
